(19) United States
(12) Patent Application Publication
(10) Pub. No.: US 2006/0206349 A1
(43) Pub. Date: Sep. 14, 2006

(54) Search equity program system and method

(76) Inventor: Daniel M. O'Donnell, San Francisco, CA (US)

Correspondence Address: OSTROLENK FABER GERB & SOFFEN, 1180 AVENUE OF THE AMERICAS, NEW YORK, NY, 100368403, US

(21) Appl. No.: 11/157,418

(22) Filed: Jun. 21, 2005

Related U.S. Application Data
(60) Provisional application No. 60/659,465, filed on Mar. 8, 2005.

(51) Int. Cl. G06Q 99/00

(52) U.S. Cl. 705/1

(57) ABSTRACT

The invention provides for a method for receiving revenue by brokering searches for content available over a communication network. The steps of the method include providing a private communication network secured from a publicly available communication network, transmitting a request for bids to a plurality of search engines, accepting a bid from one search engine of the plurality of search engines, receiving a search request from the user while the user is connected to the private network, transmitting the search request to the one search engine and receiving search results from the one search engine in response to the search request, providing the search results to the user, and receiving a fee from the search engine. The bids represent fees paid by the search engines for providing search results in response to a search request for content that is located on a communication network and submitted by a user connected to the private network.

### CROSS-REFERENCE TO RELATED APPLICATIONS

This application is based on and claims priority to U.S. Provisional Patent Application Ser. No. 60/659,465, filed Mar. 8, 2005 and entitled Revenue Sharing and Internet Search Brokering System and Method, the entire contents of which are incorporated herein by reference.

### BACKGROUND OF THE INVENTION

1. Field of the Invention

The present invention relates to on-line searching, and, more particularly, to generating revenue from Internet searches performed by users connected to a private network.

2. Description of the Related Art

Internet web sites provide various forms of content and functionality that many network users, e.g., employees, require in order to complete tasks required of their employment. Internet access is, therefore, provided to millions of network users around the world as a tool for performing their respective jobs.

Network users use Internet access that is provided by their employers for business and/or personal use. For example, during business hours, many network users peruse (“surf”) web sites that are not directly related to their jobs, thereby resulting in lower network user productivity and, in some cases, reductions in available bandwidth for those that are using the Internet access for business or otherwise legitimate purposes.

Referring now to the drawings, in which like reference numerals refer to like elements, there is shown in FIG. 1 an example of a typical prior art hardware arrangement of computing devices that communicate with Internet search engines over a communication network, and referred to herein, generally, as system 100.

In the typical environment shown in FIG. 1, search engines 102 receive search requests for sources of content from workstations 104 over communication network 105. Network 105 can be any communication network, and preferably is a global communication network such as the Internet. In response to the search requests, search engines 102 provide search results to workstations 104 that include links to web sites provided by respective on-line content providers 106.

Some of the hardware devices arranged in FIG. 1 are provided within private network 107 and “behind” security system 108. Private network 107 may be configured in a variety of ways, including as a local area network (“LAN”), a wide area network (“WAN”) or another known configuration. Security system 108 protects hardware devices provided on network 107 from potential on-line attacks from an outside source, such as a malicious hacker. Typically, security system 108 includes, for example, proxy server 110 and firewall 112. Of course, one skilled in the art will recognize that company security system 108 can be configured in a variety of ways, and may include fewer or more hardware devices. For example, proxy server 110 and firewall 112 may be incorporated in a single hardware device. Alternatively, proxy server 110 and firewall 112 may include other physically separate devices that include, for example, a router, personal computers, a dedicated firewall, and/or some other computer-related hardware.

In addition to securing computing devices from attacks from outside sources, methods and systems are know which monitor, restrict or prevent network users from visiting specific Internet web sites, particularly while on the job. For example, software is known that operates to filter Internet traffic in order to restrict a network user's access to particular web sites. In one known case, filtering software operates within security system 108 and references a list of uniform resource locators (“URLs”) to prevent unauthorized access thereto. Typically, the filtering software displays a pre-configured page (e.g., written in the hypertext markup language, “HTML”) to a user who attempts to access one of the URLs in the list. Thus, the filtering software operating within security system 108 essentially functions to reroute unauthorized hypertext transfer protocol (“HTTP”) requests to the pre-configured page.

Other techniques for filtering access to Internet web sites are known. For example, content filtering software can be configured to reference a list of keywords (as opposed to URLs) that are included in the web site (e.g., in meta-tags or HTML placed on the page). Further, web browser software applications, (e.g., MICROSOFT INTERNET EXPLORER, NETSCAPE NAVIGATOR and MOZILLA FIREFOX) can be configured to restrict access to only a predefined list of web sites (e.g., “trusted sites”). Thus, content-filtering techniques can be provided in a web browser software application, rather than in a central location, such as firewall 112.

In addition to restricting access to one or more web sites based on filtering methods, computer tracking software is known that can be installed on a computer system to monitor computer-related actions (e.g., keystrokes, mouse-clicks, and automatic activity) taken by a network user. Thus, employers can use affordable and available software to monitor network user Internet activity, and even restrict users from accessing specific search engines in order to prevent network users from performing personal searches for content located on the Internet.

Employers vary in their positions with respect to network users' personal Internet use during business hours or while on the job. Some employers have a policy of terminating network users who peruse the Internet for personal reasons. Others allow unrestricted (and/or unmonitored) Internet use provided network user productivity is unaffected. Thus, there is little uniformity in the business world with respect to network users' Internet use.

Many network users use publicly accessible search engines, such as provided at www.google.com, www.yahoo.com, www.msn.com and www.askjeeves.com to locate content provided on Internet web sites. As noted above, some network users use publicly accessible search engines to locate web sites primarily for professional reasons, such as to locate web sites containing content required for work, while others search for personal reasons. In either case, search engines remain an extremely common tool for network users and/or users of workstations 104 operating on private network 107 to locate content on the Internet.

Search engines earn revenue in a plurality of ways, as generally illustrated in the block diagram shown in FIG. 2. For example, as shown in FIG. 2, pay-per-click revenue 202, featured sites revenue 204, revenue from sales of keyword search terms 206, advertising revenue 208 and sales of search engine technology 210 result in a search engine 102 becoming profitable. Other techniques for generating and/or receiving revenue for search engine 102 may be known to those skilled in the art, and are incorporated herein by reference. The example revenue generating opportunities, such as those illustrated in FIG. 2, are described below.

With regard to pay-per-click revenue 202, search engine 102 generates revenue each time a user of the search engine selects a hyperlink (typically formatted as an icon or a brief textual description) that is placed in the search engine display screen. Often referred to as “banner advertisements,” the hyperlink represents an advertisement for goods and/or services provided by a content provider, and, when selected, directs a web browser software application to the content provider's web site. In a typical example, a provider of goods and/or services pays the search engine a fixed amount of money each time the hyperlink is selected by a user. Also referred to in the industry as “cost-per-click,” search engines can make considerable amounts of money from advertisements that are selected by, for example, network users who are surfing Internet web sites while at work. One skilled in the art will recognize similar models to pay-per-click revenue 202 can be provided. For example, revenue 202 may be generated when a user actually completes a sales transaction after selecting a provider's banner advertisement. Thus, revenue 202 can be generated in response to a selection of a banner advertisement in various ways.

In an alternative and known search engine revenue generation technique, so-called “featured sites” revenue 204 is generated by charging a fee to a company (or other party) that seeks prominent placement in a search list provided by a search engine in response to a user's search query. A hyperlink is prominently displayed, for example, when it is listed at or near the top of a list of search results. Of course, one skilled in the art will recognize that a hyperlink can be prominently displayed in various other ways, such as by increasing the point size of a textual hyperlink, formatting the hyperlink in a particular color, placing asterisks or other characters at or near the hyperlink, or by positioning hyperlinks in an area of a screen display that is set off from other hyperlinks (e.g., to the right or left in the display screen). In these ways, hyperlinks to featured sites are distinguished from hyperlinks to non-featured sites, and are believed to be more likely to be selected by a searcher. Revenue 204 is generated when proprietors of Internet web sites, typically who sell good or services, pay a fee to a search engine that prominently displays hyperlinks to the proprietors' web sites in response to a searcher's keyword search.

Yet another model for generating revenue by a search engine and illustrated in FIG. 2 regards advertisement revenue 206 wherein a search engine enables a proprietor to create an advertisement (distinct from the above-identified banner advertisement), and to identify keywords that correspond to the advertisement. In accordance with one known example, GOOGLE'S ADWORDS (sponsored by www.google.com), the proprietor pays only when someone clicks on the advertisement. Of course, one skilled in the art will recognize that alternative methods can be fashioned in various ways. Techniques to generate revenue 206 are perceived as useful for search engines, as well as for providers of goods and services who can create ads easily and enable the search engine to match the advertisements to a respective audience.

Other techniques for a search engine to generate revenue are known. For example, a search engine can generate revenue 208 from advertisements regarding the search engine placed on other Internet web sites, as well in conventional media (i.e., radio, television and printed media). An advertising campaign may be an effective way for a search engine to attract visitors and, accordingly, generate revenue. Moreover, a search engine may generate revenue 210 by selling information regarding the search technology utilized by the engine. For example, a company may desire to provide search engine technology to visitors of its web site. By paying a search engine for information to enable the company to provide searching capability, the search engine generates revenue 210.

Thus, search engines utilize various methods to generate revenue. Moreover, revenue generated by search engines is directly attributable to searchers who are looking for content while on the job and/or during business hours. It is believed by the inventor that for each one thousand network users searching the Internet for content during business hours, approximately three hundred dollars ($300.00 US) can be earned per day by the search engine. This represents an earning for the search engine equal to approximately $75,000.00 per year per one thousand network users. Thus, a large corporation that employs over 10,000 network users may be generating over $750,000.00 annually, collectively for a plurality of search engines, from employees or other network users performing Internet searches.

Evidence of Internet search traffic (i.e., use of Internet search engines) indicates that Monday is the highest traffic search day of the week, while Saturday and Sunday are the lowest. In other words, evidence supports the theory that network users use search engines to locate web site content most frequently during business hours.

Moreover, it is believed by the inventor that a network user performs on the average of three to five searches per day on a major search engine, both for work-related and non-work-related purposes. This search activity represents a majority of traffic to the major search engines, and is directly responsible for the rapidly growing revenue streams and market capitalization (such as described above) that major search engines have experienced. Yet the corporations who supply the computers, network infrastructure and Internet bandwidth for all of this activity receive no recompense or reimbursement for the use of these assets, nor do they receive any reimbursement for the productive time lost to non-work-related searching.

### SUMMARY OF THE INVENTION

The forgoing illustrates a need in the industry to enable businesses that have network users who use search engines to search for content on the Internet to enjoy a percentage of the revenue earned by search engine resulting from network user searches.

In a preferred embodiment of the present invention, the present invention comprises a system and method that provides corporations with a share of the revenue stream that is generated by search engine traffic and that originates from corporate networks. In one embodiment of the present invention, a favorable revenue sharing relationship is negotiated with search engine entities, and, accordingly, a share (for example, up to 25%) of each search engine's revenue stream is shared with the corporations having network users who conduct the searches.

In one embodiment, the present invention includes a method for receiving revenue by brokering searches for content available over a communication network. In this embodiment, the method includes providing a private communication network secured from a publicly available communication network, such as the Internet. A request for bids is preferably submitted to a plurality of search engines, in which the bids represent fees paid by the search engines for providing search results in response to search requests for content that is located on a communication network and submitted by a user connected to the private network. Bids are preferably received from at least one of the search engines, and one of the bids is from one of the search engines.

In an alternative embodiment, a search request is received from a user while the user is connected to the private network, and the search request is transmitted to the one search engine. Search results are received from the one search engine in response to the search request, and the search results are provided to the user. The search engine provides the fee in accordance with its bid.

Preferably, a search results display screen is provided to the user, which is formatted to receive the search request from the user, and further displays the results of the search received from the search engine. Moreover, the search results display screen preferably includes an identifier representing the search engine from which the search results were received. For example, the identifier may be the name of the search engine, or it may be an image representing the search engine. Further, the search results display screen preferably includes at least the name of an organization providing the search results display screen.

Alternatively, a graphic control is provided in a web browser software application that is formatted to receive input from the user, wherein the input is the search request. Preferably, the revenue is generated by the search engine from at least one selected from the group consisting of pay-per-click revenue, featured sites revenue, and sales of keyword search terms.

In yet another embodiment, a proxy server intercepts an HTTP request from the user's web browser software application for establishing a communication session with a search engine. Thereafter, a communication session is established with the user's web browser software application and a HTTP server other than the search engine. The HTTP server displays a HTML file having a control formatted to receive input from the user in the user's web browser software application. The user submits the search request in the control, and the search request is transmitted to a search engine. The search engine preferably generates revenue as a result of the search, and provides search results, which are, thereafter, displayed in the HTML file. The search engine further provides a fee, which represents at least a portion of the revenue, generated as a result of the search.

Other features and advantages of the present invention will become apparent from the following description of the invention, which refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates an example of a prior art hardware arrangement of computing devices that communicate with Internet search engines over a communication network;

FIG. 2 is a block diagram illustrating how search engines earn revenue in a plurality of ways;

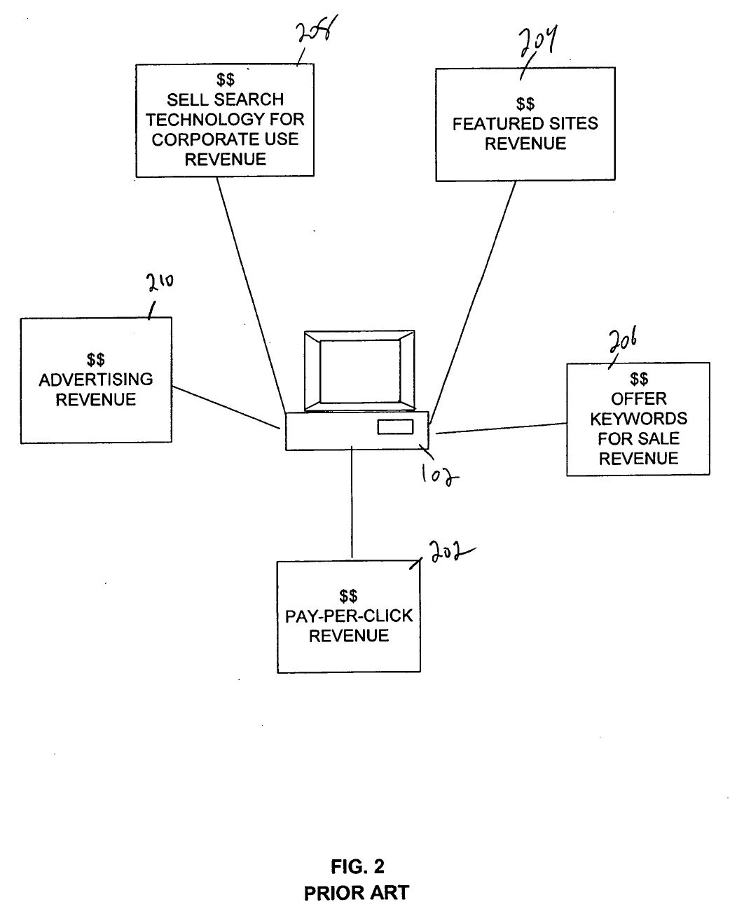

FIG. 3 illustrates an arrangement of hardware devices provided in accordance with a preferred embodiment of the present invention;

FIG. 4 shows the functional elements of a proxy server in accordance with an embodiment of the present invention;

FIG. 5A is an example search results display screen that is provided by a proxy server to a user of a workstation operating on a private network;

FIG. 5B illustrates an alternative example search results display screen;

FIG. 6 is a block diagram illustrating a plurality of computing devices and further illustrating the flow of the percentage of revenue that is received by proxy servers;

FIG. 6a illustrates an embodiment of the present invention, which includes an intermediary;

FIG. 7 is a flow chart that identifies steps associated with receiving search results from one of a plurality of search engines;

FIG. 8 is a flow chart that identifies steps in an alternative embodiment associated with receiving search results from one of a plurality of search engines; and

FIG. 9 is a flow chart that includes steps associated with an embodiment of the present invention.

### DESCRIPTION OF THE INVENTION

In accordance with the present invention, a system and method is provided for enabling businesses, for example, corporations, to collect revenue from one of the most common network user activities on the Internet: searching for content on the Internet via publicly accessible search engines. The present invention comprises a system and method that provides corporations with a share of a revenue stream to a search engine that is generated by search engine traffic and that originates from private and/or corporate networks. In one embodiment of the present invention, a favorable revenue sharing relationship is negotiated with search engine entities, and, accordingly, a share (for example, up to 25%) of each search engine's revenue stream is shared with corporations having network users who conduct the searches.

As used herein, a “network user search” refers, generally, to a search performed by a network user of a business for content that is locatable on the Internet. More generally, any search that is performed by a network user, or any other party who uses a workstation operating as a business or other private computer network to perform a search over the Internet for any content, is referred to herein as a “network user search.”

In an embodiment of the present invention, revenue is generated by the present invention that may amount to, for example, twenty percent (20%) of the revenue earned annually by a search engine resulting from searches performed by network users of a respective business. As described above, evidence indicates that search engines realize approximately $75,000.00 per year per one thousand network users. Twenty percent of that revenue, which can be earned by a business using the present invention, equals approximately $15,000 per one thousand network users, annually. Thus, a firm with 10,000 network users, for example, uses the system and methods described herein to generate up to $150,000 annually. Such revenue can be used for any purposes the corporation might deem appropriate, for example, to underwrite the costs of the corporate network, to fund new initiatives, for charitable giving programs, or simply as an enhancement to bottom line income. A benefit of the present invention is that a relative minimal investment is required of management, including time and/or resources, thereby resulting in a margin on such “found revenue” that is extremely high.

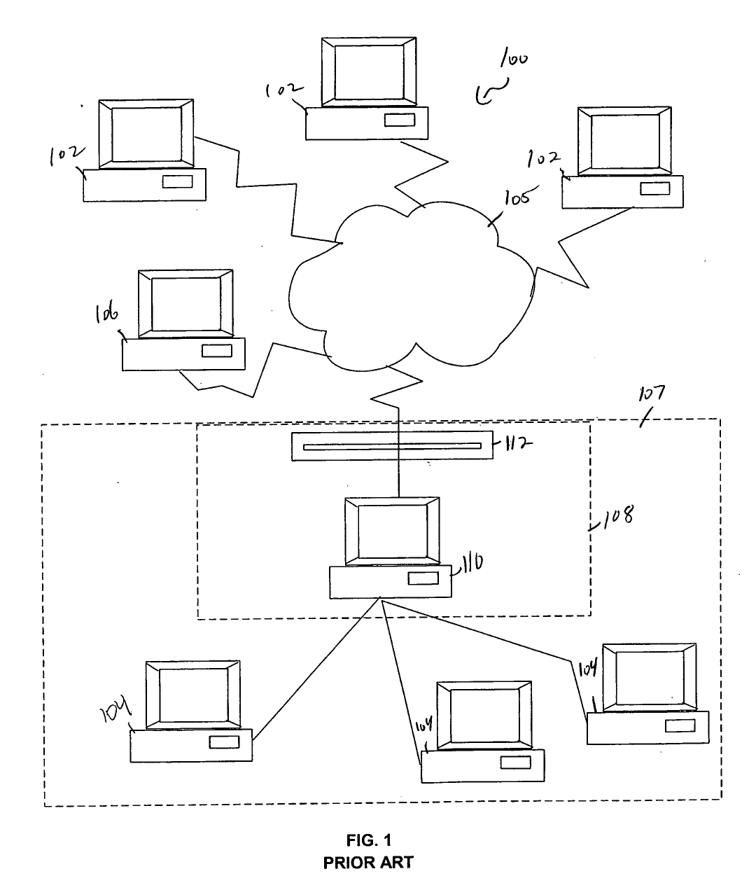

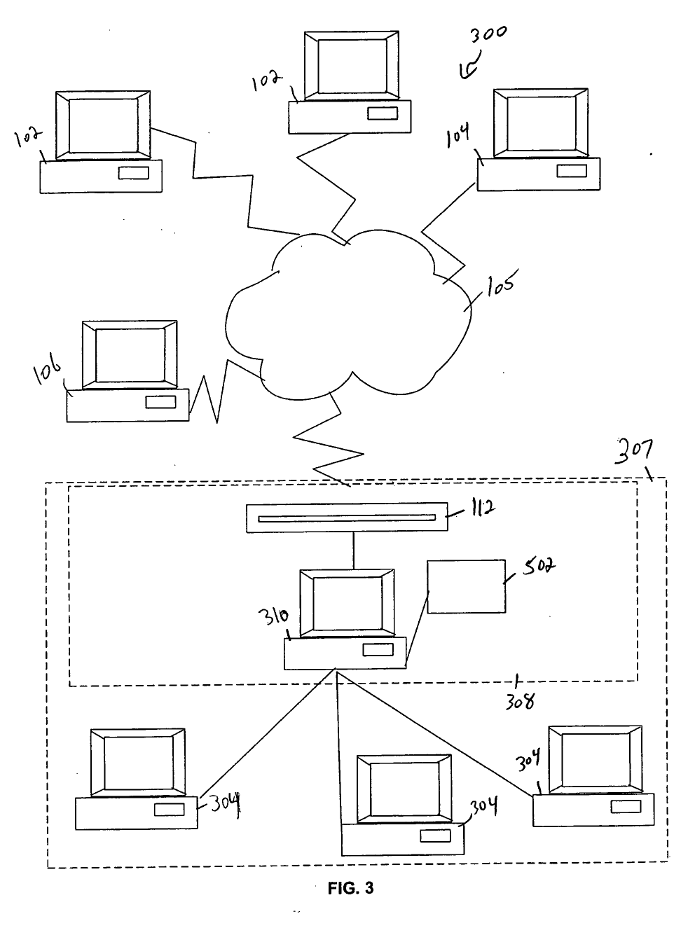

Referring now to FIG. 3, an arrangement of hardware devices provided in accordance with a preferred embodiment of the present invention is shown and referred to herein, generally, as search equity system 300. Many of the hardware devices illustrated comprising search equity system 300 are the same as those illustrated in FIG. 1. Unlike system 100, however, proxy server 310 functions to provide search display 502, which, as described in greater detail below, preferably displays search results provided by one or more search engines.

In accordance with the teachings herein, the term, “proxy server” 310 is provided for descriptive purposes, and not intended to limit device 310 to function solely as a proxy server, as known to those skilled in the art. For example, device 310 may function as a web server, a file server or some other device capable of providing information content. Therefore, as used herein, proxy server 310, generally, represents a server or other device that is provided between a client application, such as a web browser software application operating on a private network, and a server that is available on a publicly accessible network. Preferably, proxy server 310 attempts to fulfill requests from client applications. Proxy server 310 is further preferably configured to forward requests from client applications to another device, for example, search engine 102.

In the embodiment of the present invention illustrated in FIG. 3, a corporation's existing proxy server(s) 310 is utilized to direct all network user search activity to a custom-branded, “search” page 502. For example, a network user seeking to locate content on the Internet makes an HTTP request by entering the name of a major search engine in the address bar of his web browser software application. The present invention preferably intercepts the HTTP request and redirects the browser application automatically to custom search page 502.

As noted above, system 300 is preferably comprised of at least one proxy server 310 and at least one workstation 304, each of which operate on private network 307 which is coupled to communication network 105. As noted above, communication network 105 is preferably a global public communication network, such as the Internet, but can also be a private value added network (“VAN”) or the like.

Proxy server 310 and user terminal 304 can be any devices that are capable of sending and receiving data across communication network 105, e.g., mainframe computers, mini computers, personal computers, laptop computers, personal digital assistants (PDA) or Internet access devices such as Web TV. In addition, user terminals 14 are preferably equipped with a web browser, such as MICROSOFT INTERNET EXPLORER, NETSCAPE COMMUNICATOR, MOZILLA FIREFOX and the like. Proxy server 310 and workstations 304 are coupled to communication network 105 using any known data communication networking technology.

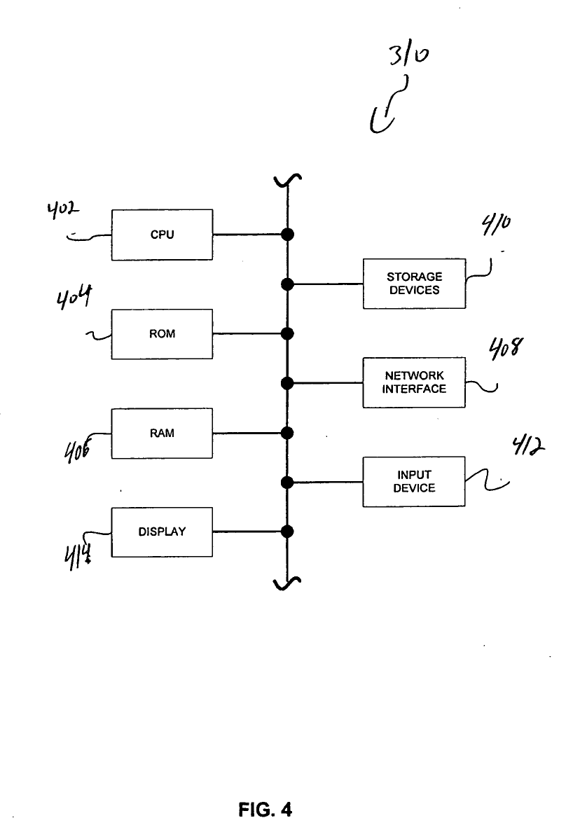

As shown in FIG. 4, the functional elements of each proxy server 310 include one or more central processing units (CPU) 402 used to execute software code and control the operation of proxy server 310, read-only memory (ROM) 404, random access memory (RAM) 406, one or more network interfaces 408 to transmit and receive data to and from other computing devices across a communication network, storage devices 410 such as a hard disk drive, floppy disk drive, tape drive, CD ROM or DVD or storing program code, databases and application data, one or more input devices 412 such as a keyboard, mouse, track ball, microphone and the like, and a display 414.

The various components of proxy server 310 need not be physically contained within the same chassis or even located in a single location. For example, storage device 410 may be located at a site which is remote from the remaining elements of proxy server 310, and may even be connected to CPU 402 across communication network 105 via network interface 408.

Proxy server 310 preferably is operable to perform functions described herein, in addition to functioning as a network gatekeeper and performing other typical proxy server functions, as known to those skilled in the art. Proxy server 310 may be equipped with sufficient storage to provide the necessary databases and other services described herein, as well as acting as a web server for communicating hypertext markup language (HTML), XML, Java applets, Active-X control programs or the like, to workstations 304. For example, when a user of workstation 304 activates web browser software, he is connected to proxy server 310 which functions as a HTTP server and provides HTML content. Preferably, proxy server 310 is arranged with components, for example those shown in FIG. 4, suitable for the expected operating environment of proxy server 310. The central processing unit(s) 402, network interface(s) 408 and memory and storage devices are selected to ensure that capacities are arranged to accommodate expected demand.

The functional elements shown in FIG. 4 (designated by reference numerals 402-414) for proxy server 310 are of the same categories of functional elements also present in workstations 304, 104, search engines 102 and content providers 106. However, not all elements need be present in all workstations 304 in the same size and configuration. For example, CPU 402 in workstation 304 is typically a smaller capacity CPU than the CPU present in the proxy server 310. Similarly, it is likely that the proxy server 310 will include storage devices of a much higher capacity than storage devices present in workstation 304.

Of course, one of ordinary skill in the art will understand that the capabilities of the functional elements can be adjusted as needed. The nature of the invention is such that one skilled in the art of writing computer executable code (software) can implement the described functions using one or more or a combination of a popular computer programming languages including, but not limited to C++, Visual Basic, Java, Active-X, HTML and web application development environments.

Although the present invention is described by way of example herein and in terms of a web-based system using web browsers and a web site server (information processor 12), system 10 is not limited to the above configuration. It is contemplated that system 10 can be arranged such that user terminals 14 can communicate with and display data received from information processors 12 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on user terminal 14, for example, WINDOWS 3.x, WINDOWS 95, WINDOWS 98, WINDOWS NT, WINDOWS MILLENNIUM, WINDOWS 2000, WINDOWS XP, WINDOWS CE, Mac OS, UNIX, LINEX, Palm OS and any suitable PDA or palm computer operating system.

As used herein, references to displaying data on user terminal 304 refers to the process of communicating data to the terminal across communication network 105 and processing the data such that the data is viewed on the terminal displays 414 using a web browser or the like. As is common with web browsing software, the display screen on user terminals 304 present sites within the networked system 300 such that a user can proceed with from site to site within the system by selecting a desired link.

Also as used herein, the term, “module,” refers, generally, to one or more discrete components that contribute to the effectiveness of the present invention. Modules can include software elements, including but not limited to functions, algorithms, classes and the like. Modules also include hardware elements, substantially as described below. Modules can operate independently or, alternatively, depend upon one or other modules in order to function.

Many of the examples provided herein concern Fortune 500 companies and the examples provided herein are for explanatory purposes and are not intended to limit the invention to any such instrumentalities. The present invention has broad applicability in other service industries, including computer programming industries, law practices, medical practices, etc.

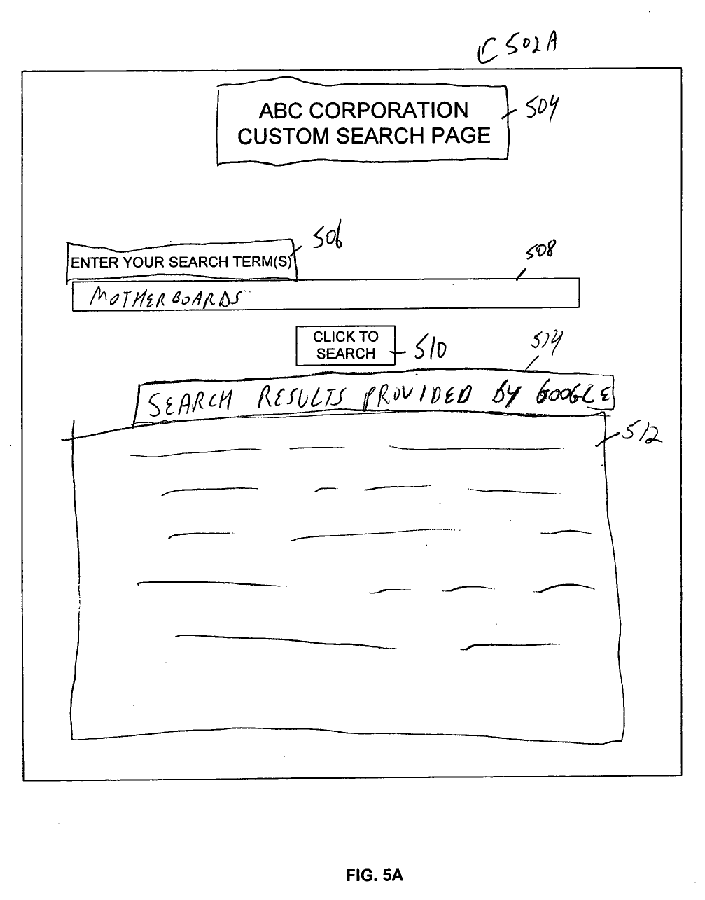

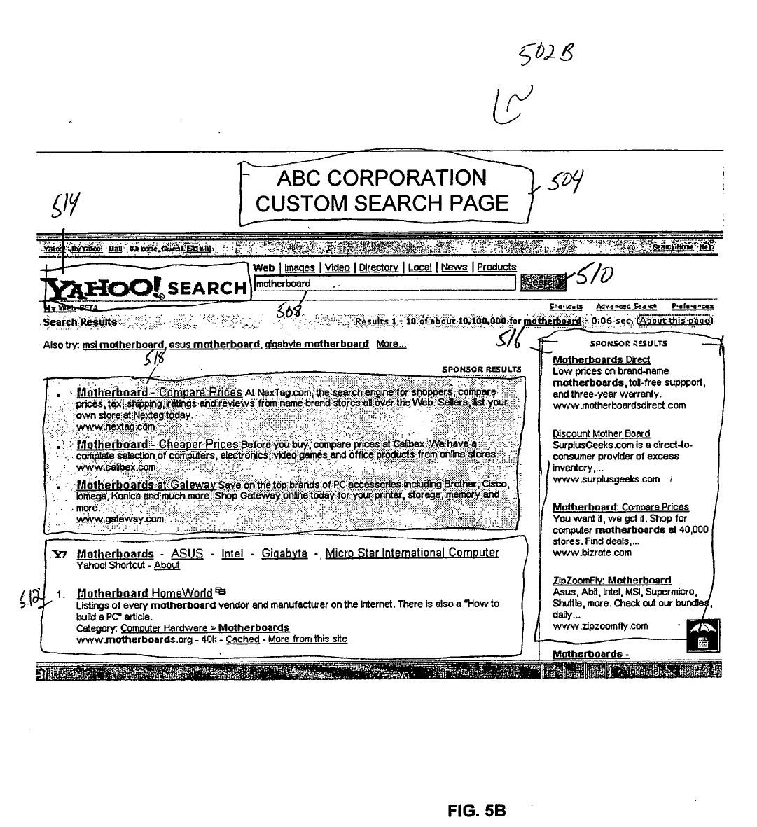

FIG. 5A is an example search results display screen 502A that is preferably provided by proxy server 310 to a user (e.g., a network user) of workstation 304 connected to private network 307 who attempts to gain access to a publicly available search engine 102. For illustrative purposes, various embodiments of display screen 502-502′ are depicted in the drawings. The embodiments illustrated in the drawings are not provided to limit the invention thereto. One skilled in the art will recognize that the present invention can be implemented in many ways, without departing from the spirit of the teachings herein.

FIG. 5A shows example search results display screen 502A that preferably includes several graphical screen components. For example, label 504 displays information regarding the organization (e.g., company name and demographic information) that employs the teachings herein. Further, display screen 502A preferably includes graphic screen controls, such as label 506 and text box 508, that are formatted to receive one or more search terms from a user of workstation 304. Button 510, when selected, preferably causes proxy server 310 to retrieve search results that are provided by a search engine, such as GOOGLE, in accordance with the teachings herein.

In the embodiment illustrated in FIG. 5A, a search results list 512 is displayed in the user's web browser display screen. The search results provided in list 512 are preferably formatted at least partially as hyperlinks such that a user viewing display screen 502A selects a hyperlink to view content related to the search. Moreover, the source of the entries in search results list 512 is also preferably displayed in text control 514. In the example shown in FIG. 5A, text control 514 identifies GOOGLE as providing the results of the user's search. Thus, for example, a user operating workstation 304 submits a search for content provided on the Internet in an interactive web form provided by proxy server 310. The submitted request is used to retrieve search results from a search engine 102 (e.g., GOOGLE), and displayed in search results display screen 502A.

As shown in FIG. 5A and described above, it is envisioned herein that the custom search page of the present invention is HTML file includes one or more graphic screen controls (e.g., textbox and button) for enabling a user of workstation 304 to search for content located on the Internet. One skilled in the art will recognize, however, that the invention is not so limited. For example, the custom search page of the present invention may be formatted simply as a toolbar or other control that is included with standard Internet browser software. In this alternative embodiment, the toolbar (or other control(s)) functions to receive a search request (e.g., a keyword search) from a user of workstation 304 and to cause proxy server 310 to receive search results from at least one of a respective search engine, substantially as described herein. The results from the keyword search are preferably displayed in the display screen 502. HTTP requests for Internet search engines are preferably intercepted and a requestor's browser is redirected to a custom search page.

The redirect process, described above, is preferably implemented via the installation of a configuration file on proxy server 310. The configuration file preferably includes instructions that are implemented by proxy server 310 to intercept the HTTP request and direct the user's browser application to custom search page 502. Of course, one skilled in the art will recognize that methods of implementing and utilizing configuration files are known, and it is envisioned herein that the configuration file may be installed on one or more proxy servers 310, one or more web servers, or on a user's workstation 304, depending upon a particular embodiment of the present invention.

Various embodiments of the present invention are envisioned herein, for example, with respect to the implementation of custom search page 502 and the search results that are displayed therein. In one embodiment, custom search page 502 of the present invention displays search listings and indicates the source of the search results, as described above and illustrated in FIG. 5A. In alternative embodiment, after a user of workstation 304 submits a search request, the user's browser is directed to the particular search engine, for example, GOOGLE, and search results are provided therein, in response to the user's search. In this alternative embodiment, the user's browser is automatically directed to the search engine (e.g., GOOGLE), and the search results are displayed therein.

In an alternative embodiment, when a network user attempts to connect to a search engine, such as www.yahoo.com, a message is displayed that states that the network user is not permitted to access the respective site over the network the user is using. For example, a message is displayed that states “You are not allowed access www.yahoo.com over this network.” In this way, users are notified of restrictions to search engines upon at least a first attempt to connect thereto.

In an alternative embodiment of the present invention, search results display screen 502 includes properties of the search engine that provides search results to users of workstation 304. For example, display screen 502 is formatted to have, at least partially, substantially the same public interface that is provided by the source of the search listings. For example, if GOOGLE is selected for providing search results, display screen 502 is formatted to appear substantially as GOOGLE'S publicly available web site. Thus, in this example embodiment, search results display screen 502 includes graphical and display properties of the respective providing search engine web site, thereby notifying the user of the source of the search listings in a graphical way.

FIG. 5B illustrates an example search results display screen 502B wherein the search engine, YAHOO!, provides search results in response to a search performed by a user of workstation 304. In the example shown in FIG. 5(B), display screen 502(B) includes many of the same controls described above with respect to FIG. 5(A). For example, label 504 is provided in display screen 502(B) that displays information regarding the organization that employs proxy server 310 and/or the teachings provided herein. Further, display screen 502(B) includes graphic screen controls, such as label 506 and text box 508, that are formatted to receive one or more search terms from a user of work station 304. In the example shown in FIG. 5(B), the user of workstation 304 submitted the key word search, “mother board,” in order to receive search result listings regarding computer mother boards. Further, button 510 is provided in display screen 502(B) that enables the user to cause proxy server 310 to retrieve search results from a search engine. In the example shown in FIG. 5(B), button 510 is formatted to identify YAHOO! as the source of search results.

Also included in display screen 502(B) is search results list 512 that displays results from a user's search submitted in text box 508. In accordance with YAHOO!'s business model, the example list 512 includes sponsor results section 516 which represents sites that pay for placement in search results on key words that relevant to their business. Results list 518, illustrated in display screen 502(B) represents YAHOO!'s sponsor listings program, which is a fee-based service that allows commercial web sites already listed in the YAHOO! directory to receive enhanced placement in the commercial categories of YAHOO!'s directory. Thus, in accordance with YAHOO!'s business model, sponsor listings and sponsor results appear in separate, clearly demarcated listing areas that are located in various places in YAHOO!'s Internet web site, and, accordingly, in display screen 502(B). Moreover, display screen 502(B) includes search results list 520 that are provided by YAHOO! that are not fee-based. The listings in section, so called web results, represent results from search requests provided by YAHOO!, wherein the content providers represented in the web results list do not pay for placement.

Thus, as illustrated in the example embodiment shown in FIG. 5(B), search results display screen 502(B) can be formatted to include a graphical representation of the source of the search results.

In one embodiment, custom search page 502 is displayed to users of workstations 304 and includes search results that are received from a single search engine, such as YAHOO!, GOOGLE, or other search engine. Preferably, two or more search engines are identified by the proprietor of proxy server 310 to provide search listings, at least one of which will be used to provide search listings in response to an search submitted via workstation 304. The determination of the actual source of search results is preferably based at least on an algorithm that determines revenue-optimization. The algorithm may be designed to maximize financial or capital return on network user search traffic for the business. As shown and described, in a preferred embodiment, search results are displayed in the custom-branded search page, with a clear notice as to the source of the search results. For example, a portion of custom search page 502 includes language, such as “Search results provided by Google.”

Thus, in a preferred embodiment of the present invention, a portion of the revenue generated by search engines 102 is preferably received by proprietors of proxy server 310. In this way, the present invention provides for revenue sharing and brokering of search engine requests and results.

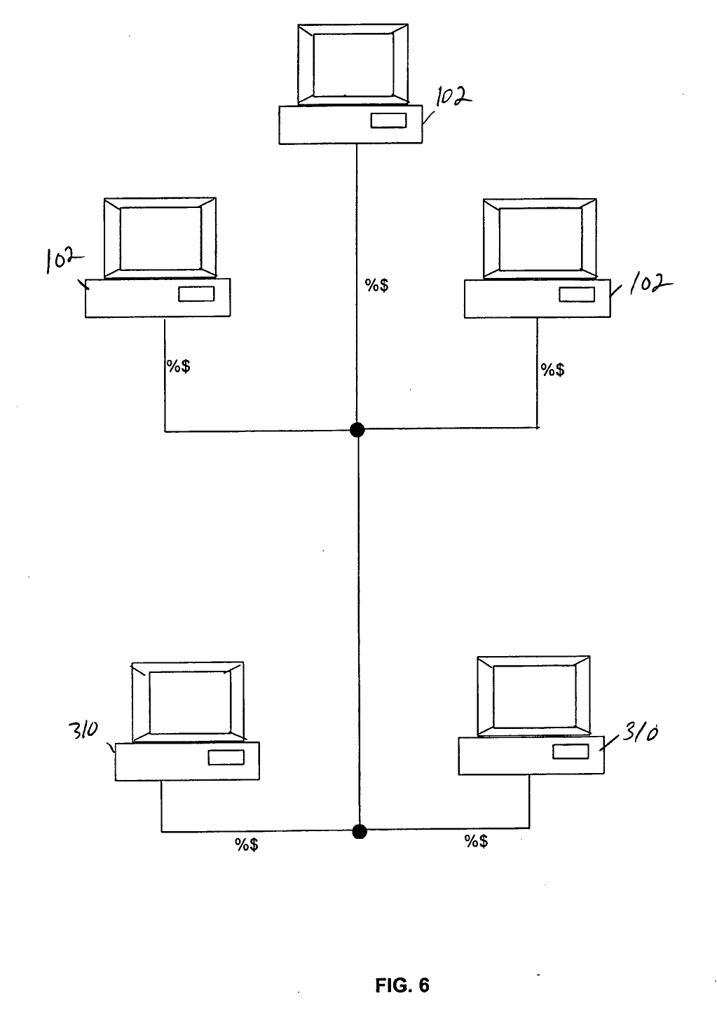

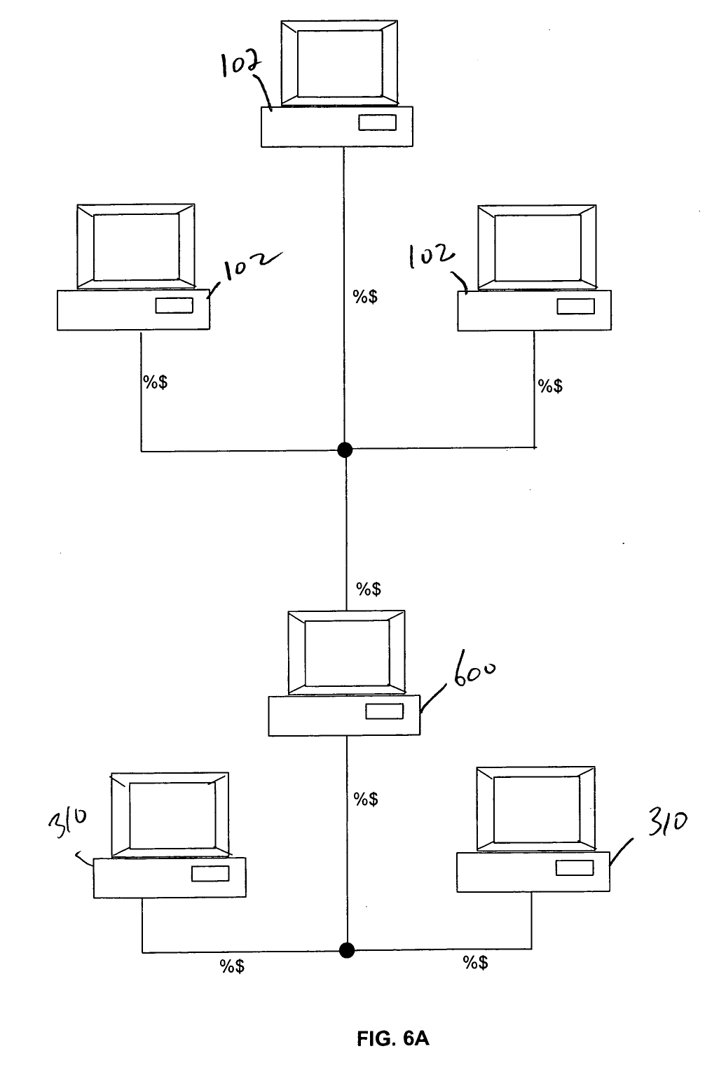

FIG. 6 is a block diagram illustrating a plurality of computing devices and illustrating the flow of the percentage of revenue that is received by proprietors of proxy servers 310. As shown in FIG. 6, search engines 102 contribute a percentage of money that is directly attributable to providing search results to users of work stations 304 and the revenue percentages are sent and received by proprietors of proxy server 310.

FIG. 6a illustrates an alternative embodiment of the present invention in which an intermediary 600 is positioned “between” search engines 102 and proprietors of proxy servers 310. Intermediary 600 preferably operates to receive revenue from search engines 102 and to forward at least a portion of the revenue to proprietors of proxy servers 310. In this way, proprietors of proxy servers 310 are not burdened with having to maintain relationships with search engines 102 and be involved in collecting revenue that they are properly entitled to in accordance with the teachings herein. Intermediary 600 may be a corporation or other entity that maintains relationships with search engines 102, and preferably functions to receive and distribute the portions of revenue generated in accordance with the teachings herein. Furthermore, in a preferred embodiment of the present invention, intermediary 600 retains a portion of the revenue generated by search engines 102 as payment for performing the functions of handling the revenue, maintaining the relationships with the search engines 102, and other related duties.

The present invention supports many ways of selecting a source of search result listings. Various metrics for selecting a source for search engine result listings can be developed and employed by those practicing the invention, without departing from the teachings herein. For example, search engines submit bids for providing search results in response to searches, and the invention evaluates the competing bids and selects the search engine that submits the highest bid. In this example embodiment, the price is preferably provided in a data feed and is based, at least in part, on historic click-through rates (estimated percentages of time users select paid-for search results) regarding particular keywords used in a search. Thus, an algorithm for selecting a particular search engine to provide search results evaluates the likelihood that a search engine will receive revenue by a searcher using the search engine. The amount represents how much revenue each keyword is likely to generate, i.e., the average click-through rate for a given keyword. Thus, in one embodiment of the present invention, the algorithm for selecting a particular search engine to provide search results represents the price per click for highest priced listing.

In yet another embodiment, the price-per-clicks for a predetermined number of search terms is calculated per average, and the present invention selects the search engine identifying the highest average. As will be apparent one skilled in the art, many other various metrics for maximizing return, such as by incorporating price-per-click, click-through-rates, flat fees or the like, can be employed for selecting a search engine to provide search result listings in response to user-specified searches. For example, GOOGLE may provide higher click-through-rates, while YAHOO may charge more money for price-per-click. Thus in this example scenario, either GOOGLE or YAHOO may be awarded the opportunity to provide search result listings, depending (at least in part) upon the metrics employed by a user of the present invention. Such metrics may also factor in time periods, for example, awarding a search engine the opportunity to provide search result listings once (e.g., per search), or over time (e.g., days, weeks, months).

In other embodiments, a flat rate (e.g., 20¢) per search may be paid by a search engine to provide a search result listing, a flat rate for a set number (e.g., 1,000) searches can be paid, or, a flat rate for providing an unlimited number of searches over a fixed period of time (e.g., one month) can be paid.

With respect to the actual search listings returned by the present invention, it is envisioned herein that the present invention may be implemented in various ways. In one embodiment, the same search engine (e.g., GOOGLE YAHOO!, or the like) is utilized for all network user searches during a fixed period of time, such as a month or annual quarter. The particular search engine that is utilized to provide search listings is preferably chosen based on the results of the algorithm, described above, designed to maximize return on network user search traffic. Alternatively, the particular search engine that is utilized to provide search listings is chosen on a per search basis. In this alternative example, after a network user performs a search (e.g., by entering keywords in a graphical screen control, such as a text box) using custom search page 502 provided by the present invention, the algorithm is used to determine which of the plurality of search engines will be selected for providing search listings in response to the network user's search. In this alternative example, a different search engine may be selected each time a network user search is performed.

In an alternative embodiment, the algorithm designed to maximize financial or capital return on network user search traffic is not used. Instead, providing an auction-type environment provides a system and method for earning revenue from search engines. As noted above, a substantial amount of revenue is generated by search engines that results from searches performed by network users during business hours. Accordingly, the present invention comprises a system and method to enable search engines to share that revenue such that a business or other party using the present invention enjoys a portion of the revenue earned by the search engines.

Continuing with this alternative embodiment, at least two search engines compete to provide search listings in response to network user searches. For example, a company with one thousand network users receives bids from at least two search engines that desire to provide search results for the company's network users. The search engine that submits the highest bid for the network user searches is awarded the search. The present invention provides the search listings from the search engine that is awarded the search via custom search page 502, substantially as described above. The bid may be in the form of a percentage value that represents a share of revenue realized by the search engine. Of course, one skilled in the art will recognize that other forms of bids are envisioned, such as a flat rate that is paid for each network user search, or a flat rate pad for an unlimited number of network user searches that are performed over a period of time.

In one embodiment, a business (or other party) accepts bids from competing search engines for network user searches that are performed over a period of time (e.g., one month) prior to awarding a contract with a single search engine to provide search listings for the network user searches performed during that month. In an alternative embodiment, a real-time marketplace is provided wherein each time a network user search is performed, search engines compete by bidding to provide search listings in response to the search. Of course, one skilled in the art will recognize that other embodiments are envisioned, such as a combination of receiving bids for a percentage (e.g., 70%) of network user searches performed over a period of time (e.g., one month), and receiving bids for providing search listings in response to network user searches that are not part of that percentage (e.g., the remaining 30%).

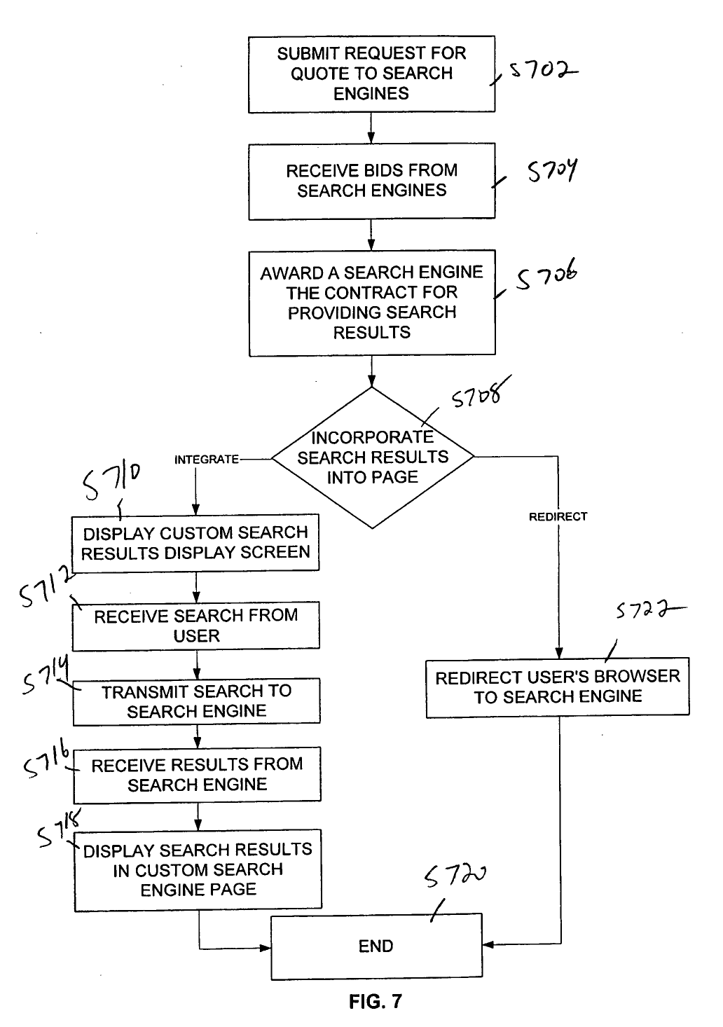

Thus, it should become apparent to one skilled in the art that determining the source for search results can be implemented in various ways without departing from the spirit and teachings of the present invention. FIG. 7 is a flow chart that identifies steps associated with receiving search results from one of a plurality of search engines. The flow chart illustrated in FIG. 7 represents an example embodiment of the present invention, and one of several ways in which a search engine can be selected among a group of search engines to provide search results in response to search requests submitted by users of work stations 304. At step S702, a request for a quote is submitted by the proprietor of proxy server 310 is submitted to search engines. For example, a business using the present invention submits a request to YAHOO! AND GOOGLE that includes the number of network users in the business. Thereafter, bids are received from search engines that represent the percentage of revenue generated by the search engines and directly attributable to, for example, the network users of the business, that each search engine is willing to remunerate to the business (step S704). At step S706, the proprietor of proxy server 310 selects one search engine to provide search results to the users of work station 304 and, accordingly, awards a search engine the contract for providing search results (step S706).

After a search engine is awarded the contract for providing search results, the proprietor of proxy server 310 makes a determination on how to incorporate search results into a display screen 502 (step S708). For example, in the event search results are to be integrated into display screen 502, then custom search results display screen 502 is preferably displayed (step S710). Thereafter, a search request is received from the user (step S712) and the search request is transmitted to the search engine that is awarded the contract for providing search results (step S714). After the search request is received and processed by the search engine, the search engine preferably transmits the search results to proxy server 310 (step S716). Thereafter, the search results received from the respective search engine are displayed in the custom search results display screen 502 (step S718). Thereafter, the process ends at step S720.

Alternatively, at step S708, the user's web browser software application may be redirected to the respective search engine web site that is awarded the contract in step S706 (step S722). After the user's web browser software application is redirected to the respective search engine, the process ends at step S720.

Therefore, as described in the flow chart shown in FIG. 7, search results can be integrated in a custom display screen 502, or, alternatively, a user can be redirected to a respective search engine.

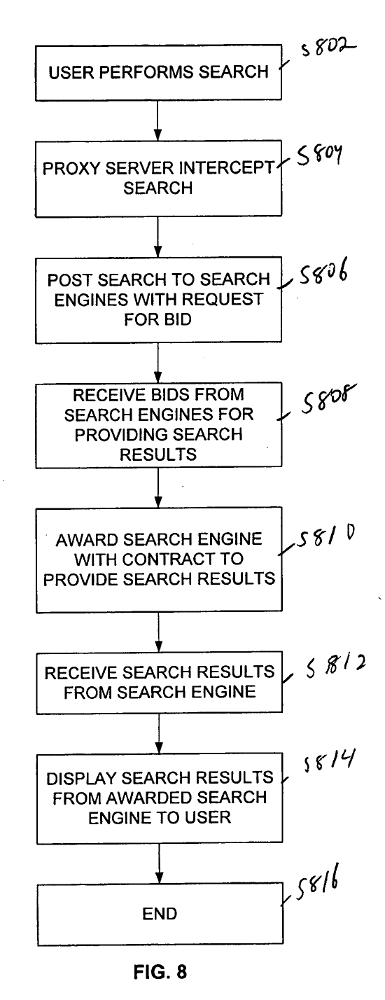

The example embodiment described above with reference to FIG. 7 regards receiving bids for providing search results from a plurality of search engines prior to a search request being received from a user of work station 304. In an alternative embodiment, contracts awarded to search engines to provide search results in response to search requests made by users of work stations 304 are awarded on a case by case basis. For example, a flow chart is provided in FIG. 8 that includes steps associated with awarding a contract for providing search results on a case by case basis. In step S802, a user of workstation 304 performs a search, such as via display screen 502. Thereafter, the search request is intercepted by proxy server 310 (step S804). Proxy server 310, thereafter, posts the search to a plurality of search engines with a request for a bid from each of the search engines for providing the search results (step S806). In step S808, bids are received from search engines for providing search results to users of workstations 304. After applying, for example, an algorithm to assess the bids received from the respective search engines, one search engine is awarded a contract to provide search results for the respective search performed in step S802. In step S812, search results are received from the respective search engine awarded the contract. At step S814, the search results received from the respective search engine are displayed in the browser of the respective user of workstation 304. Thereafter, at step S816, the process ends.

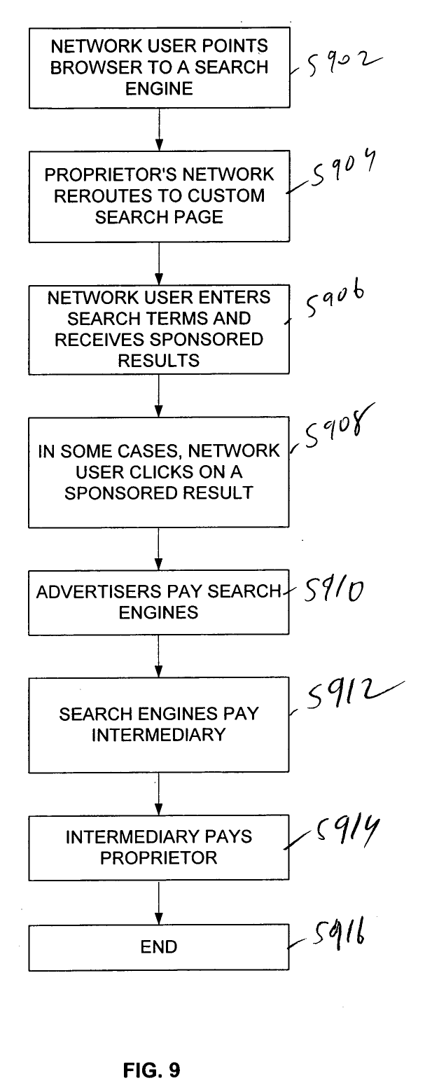

The present invention is now further described with reference to the flow chart shown in FIG. 9. FIG. 9 is a flow chart that includes steps associated with an embodiment of the present invention. In step S902, a network user, such as an employee, points his web browser to a major search engine. Thereafter, the proprietor's network reroutes the browser to the proprietor's customized search page 502 (step S904). Thereafter, the network user enters a search term and receives sponsored search results (S906). Thereafter, the network user reviews the search results in the network user's browser window (S908). In step S910, and in some cases, the network user clicks on a sponsored result. In such case, advertisers pay the search engine therefor (step S912). A portion of the revenue is paid by the search engines to an intermediary company (step S914). For example, the intermediary receives revenue from a plurality of search engines in accordance with the teachings herein, and distributes at least some of the revenue to companies that employ the teachings of the present invention. At step S916 the process ends. Thus, in accordance with the present invention, revenue can be generated from parties searching the Internet for various forms of content, and distributed via one or more intermediaries.

As noted above, in an alternative revenue-generating model envisioned herein, positions an intermediary, such as a company or other entity, “between” a plurality of search engines and respective organizations employing the teachings herein. For example, a company that has established an Intranet and a proxy server that either directly or indirectly receives search results via custom search page 502, enters into an arrangement with the intermediary to negotiate and handle revenue generated by the present invention. For example, the intermediary establishes relationships with search engines and proprietors of networks that employ the teachings of the present invention. By working with an intermediary, companies and other organizations that wish to be availed of the benefits of the present invention can realize time and cost savings by an intermediary that handles business related activity with a plurality of search engines. The intermediary preferably receives a portion of the revenue generated by the present invention, and retains that portion prior to remunerating the balance to respective entities that apply the principles of the present invention.

As illustrated in the example flowcharts shown in FIGS. 7-9, the present invention can be implemented in various ways. In one example, the search engines bid to provide search results in response to users' search requests performed on work station 304 in advance and for a set period of time. In an alternative embodiment, search engines bid to provide search results on a case by case basis. Other business models are envisioned herein, without departing from the sprit and the teachings herein. For example, search engines may be awarded contracts to provide search results for a week, month or a year, depending upon the respective business model employed. Alternatively, for example, search engines may provide search results for a set number of search requests performed by users of workstations 304. For example, one search engine provides search results for every fifty searches performed by users of work stations 304, while a different search engine provides search results for the following fifty search requests performed by users of work stations 304. Thus, the present invention is not limited to the precise embodiments and instrumentalities described in the corresponding reference figures.

In a preferred embodiment, the present invention comprises at least four revenue opportunities: two opportunities originating from server-side processes and two opportunities originating client side processes.

On the server side, network users are redirected to a custom search page that provides search results from one of a plurality of search engines. A first revenue stream is realizable by pay-per-click advertisement revenue each time a network user search is conducted and the network user (or other party conducting the search) selects an advertisement displayed. In this embodiment, the custom search page of the present invention includes search results from the search engine and, further, includes advertisement hyperlinks (e.g., icons) provided by the search engine.

A second revenue opportunity exists when user selects a control (such as a button) to “log off” any web site. When the user selects the control and logs off, a “static” web page is preferably displayed that comprises a search control that, when used to search for content over the Internet, implements the teachings herein. For example, a network user's web browser software application displays the custom search page of the present invention whenever the network user logs off a predetermined web site. In this example embodiment, pay-per-click revenue can be generated when network users elect to search the Internet for content after being prompted to do so after logging off an Internet web site. These two revenue opportunities are preferably provided as server side processes, and function as a result of instructions implemented on a server, such as a private network proxy server 310.

Additional revenue opportunities are envisioned herein that are particular to processes that are initiated on a local “client” computer system, referred to herein and known in the art, generally, as the “desktop.” For example, a revenue opportunity exists by providing a company branded toolbar that is installed in a standard web browser software application and that functions to provide custom utilities and, further, performs the functions and methods substantially as described herein. For example, the toolbar in this embodiment returns search results from a search engine that is selected in accordance with the algorithm, described above, designed to maximize financial or capital return on network user search traffic. For example, pay-per-click revenue is generated when a network user (e.g., an employee, contracted person, or other party performing the search) selects a hyperlink that is an advertisement for goods or services sold by a provider thereof.

A revenue opportunity is envisioned herein (also at the desktop) wherein a toolbar (similar to that described) is downloaded and/or installed in standard web browser software, and wherein the toolbar itself comprises an advertisement for goods or services provided by a business. Traditional advertising revenue can be generated by this custom toolbar as network users will frequently be presented with an advertisement directed to a particular good, service and/or company.

In yet another embodiment, a user operating standard web browser software connects to the Internet in order to visit a web site operated by a party, for example a business, using the present invention. The party provides a publicly accessible web site, which can be used to gain access to a secured and privately accessible web site. Once the user gains access to the secured and privately accessible web site (e.g., by submitting a user name and password), then the party can employ the teachings herein as the user is effectively a private network user.

For example, the user has a bank account at Bank A, which employs the teachings herein. The user connects to Bank A's web site for account information. The user submits authorization information, such as a user name and password, and, thereafter, is provided with his confidential bank account information. By submitting his authorization information, the user effectively establishes a secured communication session with a server operated by Bank A.

Continuing with the above example, after the user has completed reviewing his account information, he selects a hyperlink to log off of the private web site. In a typical prior art scenario, the user's browser would be directed back to Bank A's public web site. In accordance with this embodiment of the present invention, however, the user's browser is preferably directed to custom search page 502. Alternatively, Bank A's public web site may be afforded with at least one graphic screen control operable for submitting a search, such as a toolbar containing a text box and button. The graphic screen control(s) may only be provided for users who log off the Bank's private web site. Although the user selected a control to “log off” Bank A's web site, Bank A may not terminate the user's secured communication session with the server operated by Bank A. In this way, Bank A can utilize the teachings herein, and provide a transparent interface through its private network for users connecting over the Internet. Alternatively, the graphic screen control(s) are displayed in any web browser that connects to Bank A's public web site, and after a user submits a search, the methods described herein for sharing search engine revenue are employed by Bank A.

Of course, other embodiments will become apparent to those skilled in the art. For example, in yet another embodiment, proxy server 310 may not be employed at all. For example, the origination of search engine traffic can be determined and managed in other ways, such as via IP address or some other method (cookies, machine id, etc). A search engine may contract with a company (or other entity) to share revenue with that entity for all search traffic that is identified as originating from a particular source (e.g., the particular IP address, machine ID, etc). In this way, the revenue sharing model described herein can be employed without requiring, necessarily, private proxy server 310.

Preferably, the present invention tracks and monitors the effectiveness of the present invention by providing at least one of the following data reports: a) updated reports on traffic and revenue every 24 hours; and b) data mining of search terms available on demand within 48 hours. Of course, one skilled in the art will recognize that many other data reports can be provided by the present invention. Thus, feedback is provided to enable users of the present invention to recognize benefits of the present invention.

One skilled in the art will recognize that alternative embodiments and other features can be incorporated into the present invention. For example, a feature can be provided wherein the amount of revenue generated by network user searching (using the system and methods described herein) is dependent at least in part on the party making the search. For example, it is believed that executives who earn more than $75,000.00 per year are likely to perform searches for goods and services that are more expensive than are network users who earn under $35,000.00. The present invention preferably leverages information related to the financial earnings of the searcher to yield more revenue from search engines. For example, using each respective searcher's assigned IP address (or other identifier, such as user name and/or password), the present invention monitors the originating party performing a search for content on the Internet. The percentage of revenue earned by a search engine for searches performed by, for example, high-earning executives is greater than those performed by lower-earning network users. Thus, a sliding scale is envisioned herein that automatically adjusts the amount of revenue earned by parties using the present invention in view of each party's respective earning capacity. For example, the present invention may weigh in factors such as job title, company division, geographic region, company department, or other factors to account for the sliding scale, described above.

In an alternative embodiment, a sliding scale is applied for determining a percentage of revenue sharing with Internet search engines based on the number of searches performed by an individual. For example, a network user who performs many Internet searches during the course of the day may be more valuable to a search engine than the network user who performs very few searches. Therefore, it is envisioned that the degree or percentage of revenue sharing may be based at least in part on the number of searches performed by individual network users.

Thus, as described herein, the present invention provides a new way for businesses (and/or operators of private networks) to earn revenue that is inexpensive and continual. Using the system and method disclosed herein, corporations can monazite search traffic performed by their own network users. The present invention provides an alternative to prior art network user monitoring practices, and enables businesses to profit from Internet searching that network users are otherwise known to engage in.

The foregoing description of the preferred embodiment of the invention has been presented for the purposes of illustration and description. It is not intended to be exhaustive or to limit the invention to the precise form disclosed. Many modifications and variations are possible in light of the above teaching, and will be readily apparent to those skilled in the art, and this application is intended to cover any adaptations or variations thereof. It is intended that the scope of the invention be limited not by this detailed description.

What is claimed is:

1. A method for a party to receive revenue by brokering searches for content available over a communication network, the method comprising:
receiving from a user a search request for content that is located on a communication network;
transmitting the search request to a search engine;
receiving from the search engine search results corresponding to the search request; and
providing the search results to the user, wherein the search engine pays a portion of revenue the search engine received as a result of the request to the party.

2. The method of claim 1, wherein the step of providing the search results comprises displaying a search results display screen to the user and displaying at least an identifier representing the search engine.

3. The method of claim 2, wherein the identifier includes the name of the search engine.

4. The method of claim 2, wherein the search results display screen includes at least the name of an organization providing the search results display screen.

5. The method of claim 1, wherein the step of receiving the search request includes providing a graphic control in a web browser software application, wherein the graphic control is formatted to receive input from the user.

6. The method of claim 1, wherein the revenue is generated from at least one selected from the group consisting of pay-per-click revenue, featured sites revenue, and sales of keyword search terms.

7. The method of claim 1, wherein the step of receiving from the user the search request comprises:
intercepting a hypertext transport protocol request from the user's web browser software application for establishing a communication session with a first search engine;
establishing a communication session with the user's web browser software application and a hypertext transport protocol server other than the first search engine;
displaying on the user's web browser software application a hypertext mark-up language file having a control formatted to receive input from the user; and
receiving the search request in the control.

8. The method of claim 1, further comprising:
after the search request is transmitted to the search engine, establishing a communication session with a user's web browser software application and a hypertext transport protocol server other than the first search engine;
displaying on the user's web browser software application a hypertext mark-up language file having a control formatted to receive input from the user; and
populating the control with the search request for content.

9. The method of claim 1, further comprising prior to receiving from the search engine search result corresponding to the search request, transmitting the search request to a plurality of other search engines.

10. The method of claim 1, wherein the portion of the revenue is generated by at least one of the percentage of revenue earned by the search engine, a flat fee per search, a flat fee per selection of a search result, a flat fee over time, a relative fee based upon a particular user, a set fee for each user, and a fee for a set number of searches.

11. The method of claim 1, further comprising restricting the user from establishing a connection to the search engine.

12. The method of claim 11, wherein the restriction is formatted as a message displayed on the user's display screen.

13. The method of claim 1, further comprising providing reports representing search requests from users and corresponding revenue.

14. A method for a party to receive revenue by brokering searches for content available over a communication network, the method comprising:
providing a private communication network secured from a publicly available communication network;
transmitting a request for bids to a plurality of search engines, wherein the bids represent fees paid to the party by the search engines for providing search results in response to a search request for content that is located on a communication network and submitted by a user connected to the private network;
accepting a bid from one search engine of the plurality of search engines;
receiving a search request from the user;
transmitting the search request to the one search engine and receiving search results from the one search engine in response to the search request;
providing the search results to the user; and
receiving a fee by the party from the search engine.

15. The method of claim 14, further comprising receiving the fee by an intermediary from the search engine prior to the fee being received by the party, and paying at least a portion of the fee to the party.

16. The method of claim 15, wherein the intermediary retains a portion of the fee as payment.

17. The method of claim 14, wherein the step of providing the search results comprises displaying a search results display screen to the user and displaying at least an identifier representing the search engine.

18. The method of claim 17, wherein the identifier includes the name of the search engine.

19. The method of claim 17, wherein the search results display screen includes at least the name of an organization providing the search results display screen.

20. The method of claim 14, wherein the step of receiving the search request includes providing a graphic control in a web browser software application, wherein the graphic control is formatted to receive input from the user.

21. The method of claim 14, wherein the revenue is generated from at least one selected from the group consisting of pay-per-click revenue, featured sites revenue, and sales of keyword search terms.

22. The method of claim 14, wherein the step of receiving from the user the search request comprises:
intercepting a hypertext transport protocol request from the user's web browser software application for establishing a communication session with a first search engine;
establishing a communication session with the user's web browser software application and a hypertext transport protocol server other than the first search engine;
displaying on the user's web browser software application a hypertext mark-up language file having a control formatted to receive input from the user; and
receiving the search request in the control.

23. The method of claim 14, further comprising providing reports representing search requests from users and corresponding revenue.

24. A system for a party receiving revenue by brokering searches for content available over a communication network, the system comprising:
a private communication network secured from a publicly available communication network, the method comprising:
a bid generation module that transmits a request for bids to a plurality of search engines, wherein the bids represent fees paid by the search engines for providing search results in response to a search request for content that is located on a communication network and submitted by a user connected to the private network;
a bid accepting module operable to evaluate bids received from the search engines and to accept a bid from one search engine of the plurality of search engines;
a search request reception module operable to receive a search request from the user;
a search request transmission module operable to transmit the search request to the one search engine and to receive search results from the one search engine in response to the search request;
a display module operable to provide the search results to the user; and
a fee reception module operable to enable the party to receive the fee from the search engine.

25. The system of claim 24, wherein the display module displays a search results display screen to the user and displays at least an identifier representing the search engine.

26. The method of claim 25, wherein the identifier includes the name of the search engine.

27. The method of claim 25, wherein the search results display screen includes at least the name of an organization providing the search results display screen.

28. The system of claim 24, wherein the search request receiving module provides a graphic control in a web browser software application, and wherein the graphic control is formatted to receive input from the user.

29. The system, of claim 24, wherein the revenue is generated from at least one selected from the group consisting of pay-per-click revenue, featured sites revenue, and sales of keyword search terms.

30. The system of claim 24, wherein the a search request reception module is operable to:
intercept a hypertext transport protocol request from the user's web browser software application for establishing a communication session with a first search engine;
establish a communication session with the user's web browser software application and a hypertext transport protocol server other than the first search engine;
display on the user's web browser software application a hypertext mark-up language file having a control formatted to receive input from the user; and
receive the search request in the control.

31. The system of claim 24, further comprising a report module operable to provide reports representing search requests from users and corresponding revenue.
